(19) United States
(12) Patent Application Publication
(10) Pub. No.: US 2009/0040015 A1
(43) Pub. Date: Feb. 12, 2009

(54) REMOTE CONTROL SYSTEM CAPABLE OF SEARCHING ELECTRONIC APPARATUS

(75) Inventor: Wen-Chih Teng, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CORETRONIC CORPORATION, Hsinchu (TW)

(21) Appl. No.: 11/946,829

(22) Filed: Nov. 28, 2007

(30) Foreign Application Priority Data
Aug. 8, 2007 (TW) 96129219

(51) Int. Cl. G05B 19/02

(52) U.S. Cl. 340/5.1

(57) ABSTRACT

A remote control system capable of searching an electronic apparatus is provided. Transceivers are respectively disposed in a remote controller and the electronic apparatus, such that a two-way signal transmission between the remote controller and the electronic apparatus is achieved. The product information of the electronic apparatus is obtained via the remote controller, so as to identify whether the electronic apparatus is a desired electronic apparatus or not.

### CROSS-REFERENCE TO RELATED APPLICATION

This application claims the priority benefit of Taiwan application serial no. 96129219, filed Aug. 8, 2007. The entirety of the above-mentioned patent application is hereby incorporated by reference herein and made a part of this specification.

### BACKGROUND OF THE INVENTION

1. Field of the Invention

The present invention relates to a remote control system. More particularly, the present invention relates to a remote control system capable of searching an electronic apparatus.

2. Description of Related Art

A theft problem may occur on a general electronic apparatus, such as a projector, a display device and a notebook computer etc. Taking the projector as an example, a general security approach is to add a lock to the back of the projector for connecting the projector with a tabletop via steel wires, so as to prevent the theft. However, a thief may easily steal the projector by just cutting the steel wires, and due to a similar appearance of the electronic apparatus of the same type, the lost apparatus is hard to find back. Meanwhile, identification of the lost electronic apparatus is not easy.

In addition, public electronic apparatus may be easily lost or mixed due to its many users, and the problem of miss taken or losing of the apparatus happens all the time. Therefore, if each electronic apparatus can be identified by its product information, it will be easier to find the desired electronic apparatus.

However, there only a single-way signal transmission exist between a remote controller and the general electronic apparatus, by which the signals can only be transmitted to the electronic apparatus from the remote controller. The remote controller does not have a function of obtaining the product information, and the electronic apparatus is generally equipped with a receiver only, which cannot send data out.

### SUMMARY OF THE INVENTION

The present invention is directed to a remote control system capable of searching an electronic apparatus. Product information is stored in the electronic apparatus, and a remote controller may obtain the product information of the electronic apparatus, such that the electronic apparatus is identified.

Additional aspects and advantages of the present invention will be set forth in the description of the techniques disclosed in the present invention.

To achieve one of or all aforementioned and other advantages, an embodiment of the present invention provides an electronic apparatus, which may automatically output the product information wirelessly in response to a request signal from the remote controller, such that a user having the remote controller may read the product information of the electronic apparatus and identify whether the electronic apparatus matches the remote controller.

An embodiment of the present invention provides a remote controller, which has a wireless transceiver, and may receive the product information from the electronic apparatus.

An embodiment of the present invention provides a remote control system including a remote controller, a first memory unit, and a first wireless transceiver. The remote controller has a function of transceiving signals; the first memory unit and the first wireless transceiver are disposed in an electronic apparatus corresponding to the remote controller, such that the electronic apparatus may also have the function of transceiving signals. The electronic apparatus may output the product information stored in the first memory unit to the remote controller in response to a request signal from the remote controller, such that a user may identify whether the electronic apparatus is a desired one via the remote controller directly.

Since the transceivers are respectively disposed in the remote controller and the electronic apparatus, such that a two-way signal transmission between the remote controller and the electronic apparatus is achieved. Therefore, the user may obtain the product information of the electronic apparatus via the remote controller to identify whether the electronic apparatus matches the remote controller.

Other objectives, features and advantages of the present invention will be further understood from the further technology features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a schematic diagram illustrating a remote control system integrated into an electronic apparatus according to a first embodiment of the present invention.

FIG. 2 is a schematic diagram illustrating a remote control system integrated into a projector according to a second embodiment of the present invention.

### DESCRIPTION OF EMBODIMENTS

It is to be understood that other embodiments may be utilized and structural changes may be made without departing from the scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” and “coupled,” and variations thereof herein are used broadly and encompass direct and indirect connections, couplings, and mountings.

### The First Embodiment

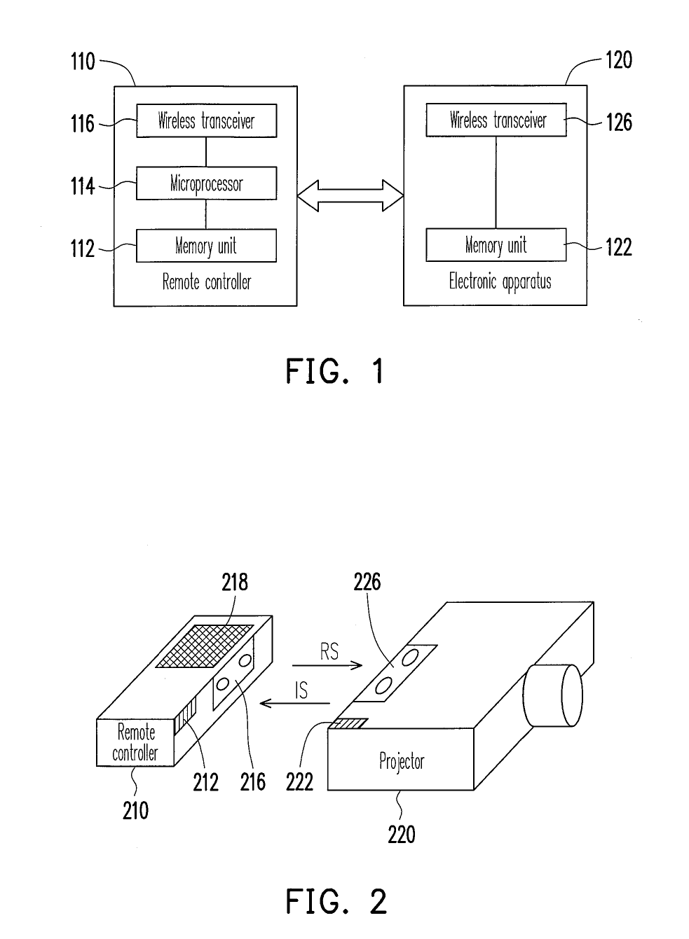

FIG. 1 is a schematic diagram illustrating a remote control system integrated into an electronic apparatus according to a first embodiment of the present invention. A remote control system includes a remote controller 110, a wireless transceiver 126 and a memory unit 122. The remote controller 110 further includes a wireless transceiver 116, a microprocessor 114 and a memory unit 112. The microprocessor 114 is coupled between the wireless transceiver 116 and the memory unit 112. The wireless transceiver 126 and the memory unit 122 are disposed in the electronic apparatus 120. The electronic apparatus 120 may be a projector, a notebook computer or a liquid crystal television.

The remote controller 110 is used for controlling the electronic apparatus 120, and the electronic apparatus 120 transmits a product information of the electronic apparatus 120 to the remote controller 110 via the wireless transceiver 126 in response to a request signal (not shown) from the remote controller 110. The product information of the electronic apparatus 120, such as a model number, a manufacturing date and a product identification code etc. are stored in the memory unit 122. When the remote controller 110 transmits the request signal to the electronic apparatus 120 for obtaining the product information, the wireless transceiver 126 may directly output the product information stored in the memory unit 122.

An authentication information corresponding to the electronic apparatus 120 is stored in the memory unit 112 of the remote controller 110 during manufacturing. When the remote controller 110 receives the product information of the electronic apparatus 120 via the wireless transceiver 116, the microprocessor 114 may compare the authentication information with the product information to identify whether the electronic apparatus 120 matches the remote controller 110. In another embodiment of the present invention, the remote controller 110 further includes a warning unit. The warning unit may be a display module used for revealing the received product information and an identifying result of the electronic apparatus 120, such that a user may quickly confirm whether the electronic apparatus 120 is a desired one. The warning unit may be a light-emitting diode (LED) or/and a loudspeaker, such that the identifying result of the electronic apparatus 120 may be revealed by light or/and sound. For example, when the searched electronic apparatus matches the remote controller, the LED may blink twice, and when the searched electronic apparatus do not match the remote controller, the loudspeaker may notify the identifying result to the user by sending a warning sound.

The remote controller 110 may not only search the matched electronic apparatus, but may also search the non-matched electronic apparatus, as long as the electronic apparatus has a function of aiding an inquiry of the product information. According to the present embodiment, the remote controller may be a handheld device that may receive signals (product information) via its wireless transceiver, such that the user may find a lost electronic apparatus via the remote controller. Therefore, the lost electronic apparatus is quickly found.

In the present embodiment, the aforementioned wireless transceiver 116 and 126 may be infrared transceivers, and the memory units 112 and 122 may be electrically erasable and programmable read only memories (EEPROMs).

### The Second Embodiment

Next, a projector and its remote controller are taken as an example to further explain the technique of the present invention. FIG. 2 is a schematic diagram illustrating a remote control system integrated into a projector according to a second embodiment of the present invention. Referring to FIG. 2, the remote controller 210 includes a wireless transceiver 216 (for example, an infrared transceiver), a memory unit 212, a build-in microprocessor (not shown), and a warning unit 218. The projector 220 includes a wireless transceiver 226 (for example, an infrared transceiver) and a memory unit 222. The projector 220 may process the signals via the build-in processor, and adding of a new processing unit is unnecessary. The projector 220 may store the product information in the memory unit 222, and the remote controller 210 may store the authentication information in the memory unit 112. If the projector 220 matches the remote controller 210, the product information is identical to the authentication information.

The remote controller 210 may transmit a request signal RS to the projector 220, and the projector 220 may return the product information IS to the remote controller 210 in response to the request signal RS, such that the remote controller 210 may judge whether the projector 220 is the desired projector. The remote controller 210 may compare the product information with the authentication information and reveal the product information IS and an identifying result via the warning unit 218, such that the related information of the projector 220 may be confirmed. By such identification, the user may quickly confirm whether the projector 220 is the lost apparatus or the desired apparatus via the remote controller 210.

In the present embodiment, the warning unit 218 may be a liquid crystal panel, used for displaying the received product information of the remote controller 210 and the identifying result of the electronic apparatus 120. The warning unit may also be a LED or/and a loudspeaker, used for revealing the identifying result of the electronic apparatus 120 performed by the remote controller 210 by light or/and sound. Moreover, components configuration of FIG. 2 is just used for an example, and has no intention for limiting the present invention. Please refer to the first embodiment for other detailed operations of the present embodiment, and detailed description will not be repeated.

In summary, a transceiver is disposed in the remote controller, such that the remote controller may has a function of receiving signals. Meanwhile, a transceiver for returning the product information is also disposed in the electronic apparatus, such that a two-way signal transmission between the remote controller and the electronic apparatus is achieved, and the lost electronic apparatus is found or the product information of the electronic apparatus is obtained via the remote controller.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A remote control system, adapted to an electronic apparatus, the remote control system comprising:
a remote controller, configured to control the electronic apparatus;
a first memory unit, disposed in the electronic apparatus, configured to store a product information of the electronic apparatus; and
a first wireless transceiver, coupled to the first memory unit, configured to transmit the product information in response to a request signal from the remote controller;
wherein the remote controller receives the product information from the first wireless transceiver to identify whether the electronic apparatus matches the remote controller.

2. The remote control system as claimed in claim 1, wherein the remote controller further comprises:
a second memory unit, configured to store an authentication information;
a second wireless transceiver, used for receiving the product information from the first wireless transceiver; and
a microprocessor, coupled to the second memory unit and the second wireless transceiver, configured to compare the authentication information with the product information, so as to identify whether the electronic apparatus matches the remote controller.

3. The remote control system as claimed in claim 2, wherein the remote controller further comprises:
a warning unit, configured to reveal the product information and an identifying result of the electronic apparatus.

4. The remote control system as claimed in claim 2, wherein the first wireless transceiver and the second wireless transceiver include an infrared transceiver.

5. The remote control system as claimed in claim 2, wherein the first memory unit and the second memory unit include an electrically erasable and programmable read only memory.

6. The remote control system as claimed in claim 1, wherein the product information includes a model number, a manufacture date and a product identification code.

7. The remote control system as claimed in claim 1, wherein the electronic apparatus is a projector, a notebook computer or a liquid crystal television.

8. A remote controller, adapted to an electronic apparatus, the remote controller comprising:
a memory unit, configured to store an authentication information;
a wireless transceiver, for receiving a product information corresponding to the electronic apparatus; and
a microprocessor, for comparing the authentication information with the product information to identify whether the electronic apparatus matches the remote controller.

9. The remote controller as claimed in claim 8, wherein the memory unit includes an electrically erasable and programmable read only memory.

10. The remote controller as claimed in claim 8, wherein the wireless transceiver includes an infrared transceiver.

11. The remote controller as claimed in claim 8 further comprising:
a warning unit, configured to reveal the received product information and an identifying result of the electronic apparatus.

12. The remote controller as claimed in claim 8, wherein the product information includes a model number, a manufacture date and a product identification code.

13. The remote controller as claimed in claim 8, wherein the electronic apparatus is a projector, a notebook computer or a liquid crystal television.
